(19) United States
(12) Patent Application Publication
(10) Pub. No.: US 2006/0209024 A1
(43) Pub. Date: Sep. 21, 2006

(54) Machine interface control method and system

(75) Inventor: Imed Gharsalli, Brimfield, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/079,088

(22) Filed: Mar. 15, 2005

(51) Int. Cl. G09G 5/08

(52) U.S. Cl. 345/161

(57) ABSTRACT

A method for processing control signals of a multi-axis joystick. The method may include processing a first control signal corresponding to movement in a first direction of the joystick and processing a second control signal corresponding to movement in a second direction of the joystick. The method may also include determining a first residue signal based on interference characteristics of the multi-axis joystick and the first and second control signals and generating a first desired control signal corresponding to the first control signal by subtracting the first residue signal from the first control signal.

### TECHNICAL FIELD

This disclosure relates generally to a machine interface, and more particularly to machine interface control methods and systems.

### BACKGROUND

A modern work machine often is equipped with several input devices, such as driving wheels, joysticks, levers, buttons, and/or keyboards, etc, to provide control interfaces to an operator to perform one or more control functions. One type of such interface device may be configured to be manipulated by an operator and control the machine by generating and sending electric signals based on the manipulation of the device, such as a joystick. The operator may move the joystick to steer the work machine or to operate other work machine components, such as a work machine tool. Many joysticks are spring-loaded so that the joystick is biased toward a central, neutral position. When the joystick is released at a location other than the neutral position, the biasing force restores the joystick to the central, neutral position.

To improve the reliability and manipulability of joystick control, multi-axis joysticks using Hall effect sensors have been developed. However, using Hall effect sensors for multi-axis joysticks may also introduce interference between different axes during simultaneous control manipulations, which may cause unwanted movement of the work machine. The unwanted movement may further hamper work machine applications and reduce work machine controllability.

To determine a desired control command from simultaneous control input signals, certain systems, such as described in U.S. Patent Application Publication No. 2003/0112219 to Gharsalli et al. (published on Jun. 19, 2003), choose individual signals based on the existence of predetermined potential conditions. However, such systems do not address issues of interference between the control signals, such as signals corresponding to different axes of a multi-axis joystick control device.

Methods and systems consistent with certain features of the disclosed systems are directed to solving one or more of the problems set forth above.

### SUMMARY OF THE INVENTION

One aspect of the present disclosure includes a method for processing control signals of a multi-axis joystick. The method may include processing a first control signal corresponding to movement in a first direction of the joystick and processing a second control signal corresponding to movement in a second direction of the joystick. The method may also include determining a first residue signal based on interference characteristics the first and second control signals and generating a first desired control signal corresponding to the first control signal by subtracting the first residue signal from the first control signal.

Another aspect of the present disclosure includes a method for operating a work machine by using a multi-axis joystick. The method may include moving the joystick in a side-to-side direction to generate a steering signal and concurrently moving the joystick in a fore-aft direction to generate a tool control signal to operate a work tool of the work machine. The method may also include processing the steering signal and the tool control signal and determining a residue signal caused by interference between signals from the side-to-side direction and the fore-aft direction based on stored information indicating interference characteristics of the multi-axis joystick. Further, the method may include subtracting the residue signal from the steering signal to generate a desired steering signal.

Another aspect of the present disclosure includes a machine interface control system. The system may include an input device configured to generate a first control signal and a second control signal. The first control signal may include a first residue signal caused by interference between the first control signal and the second control signal. The system may also include a memory device configured to store information indicating interference characteristics between the first control signal and the second control signal. Further, the system may include a controller configured to process the first control signal and the second control signal. The controller may also be configured to determine the first residue signal based on the stored information and the first and second control signals and subtract the first residue signal from the first control signal to generate a first desired control signal.

Another aspect of the present disclosure includes a work machine. The work machine may include a steering device, a work tool, and a multi-axis joystick capable of generating a first axis control signal and a second axis control signal. The first axis control signal may include a first residue signal caused by interference between the first axis control signal and the second axis control signal. The work machine may also include a controller. The controller may be configured to determine the first residue signal based on the first and second control signals and stored information indicating interference characteristics of the multi-axis joystick. The controller may also be configured to subtract the first residue signal from the first control signal to generate a first desired control signal and control the steering device of the work machine based on the first desired control signal.

### BRIEF DESCRIPTION OF THE DRAWINGS

FIG. 1 is a pictorial illustration of a work machine according to an exemplary disclosed embodiment;

FIG. 2 illustrates an exemplary base portion of a multi-axis joystick consistent with certain disclosed embodiments;

FIG. 3 provides a block diagram representation of joystick control system;

FIG. 4 illustrates an exemplary joystick signal processing flow consistent with certain disclosed embodiments;

FIG. 5 illustrates exemplary relationships among joystick control signals and residual signals; and

FIG. 6 illustrates a particular relationship among joystick control signals and residue signals.

### DETAILED DESCRIPTION

Reference will now be made in detail to exemplary embodiments, which are illustrated in the accompanying drawings. Wherever possible, the same reference numbers will be used throughout the drawings to refer to the same or like parts.

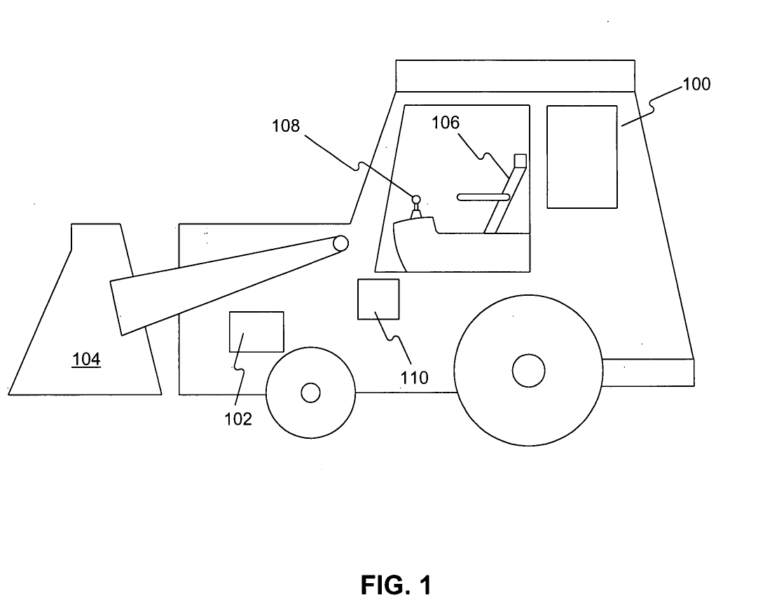

FIG. 1 illustrates an exemplary work machine 100 incorporating certain features of the disclosed embodiments. Work machine 100 may refer to any type of fixed or mobile machine that performs some type of operation associated with a particular industry, such as mining, construction, farming, transportation, etc. and operates between or within work environments (e.g., construction site, mine site, power plants, on-highway applications, etc.). Work machine 100 may also refer to any type of automobile or commercial vehicle. Non-limiting examples of mobile machines include on-highway vehicles, commercial machines, such as trucks, cranes, earth moving vehicles, mining vehicles, backhoes, material handling equipment, farming equipment, marine vessels, aircraft, and any type of movable machine that operates in a work environment. Although, as shown in FIG. 1, work machine 100 is an earth handling work machine, it is contemplated that work machine 100 may be any type of work machine. Further, work machine 100 may be conventionally powered, hybrid electric powered, and/or fuel cell powered.

As shown in FIG. 1, work machine 100 may include an engine 102, a work tool 104, an operator seat 106, a joystick 108, and a control system 110. Engine 102 may be any appropriate type of engine, such as an internal combustion engine, and may provide power to work machine 100, control system 110, and/or other components (not shown) on work machine 100. Work tool 104 may be any appropriate type of tool included on work machine 100 to handle certain type of work (e.g., a blade for earth handling work, etc.). Operator seat 106 may be provided for an operator or operators to sit during operation of work machine 100. Operator seat 106 may be any appropriate type of seat or bench used on work machines.

Joystick 108 may be any appropriate type of joystick used to control certain operations of work machine 100. For example, joystick 108 may be configured to provide control signals to a steering device (not shown), which automatically controls driving directions of work machine 100. Joystick 108 may also be configured to provide control signals to an activation device (not shown), which may operate tools on work machine 100. In certain embodiments, joystick 108 may be a multi-axis joystick using Hall effect sensors to control movement of work tool 104 and/or to steer work machine 100.

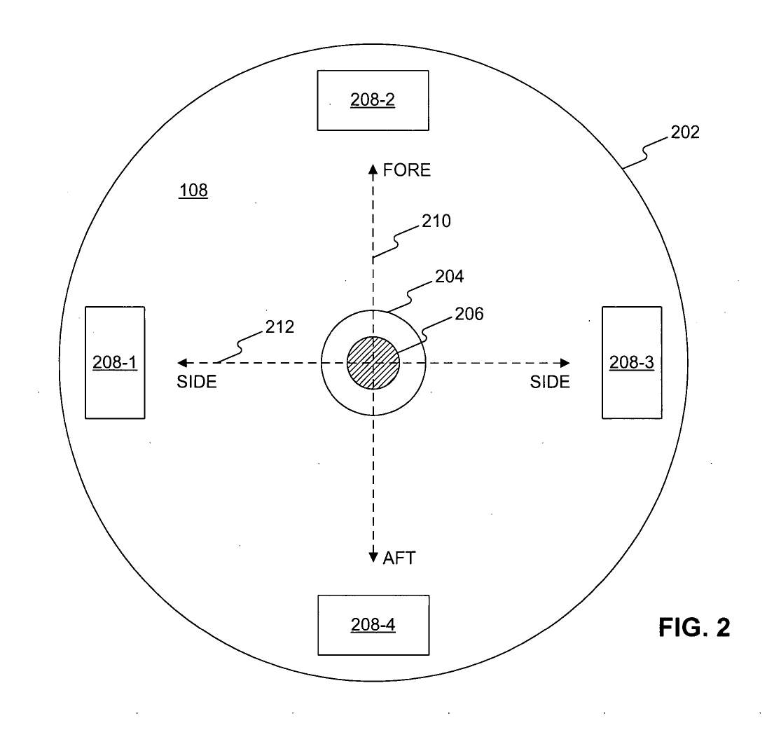

FIG. 2 shows an exemplary embodiment of a base portion 202 of joystick 108. As shown in FIG. 2, base portion 202 of joystick 108 may include actual signal generating components of joystick 108. For example, base portion 202 may include a shaft magnet 204, a shaft 206, and four Hall effect sensors 208-1 to 208-4. Hall effect sensors 208-1 to 208-4 may be any appropriate type of transducers that generate electric signals based upon the Hall effect. That is, Hall effect sensors 208-1 to 208-4 may generate electrical signals when a surrounding magnetic field changes intensity or direction. The changes in magnetic field intensity and/or direction may be caused by movement of shaft magnet 204. Shaft magnet 204 may be any appropriate type of magnet used to generate a magnetic field surrounding Hall effect sensors 208-1 to 208-4 for the purpose of Hall effect sensing.

Further, shaft magnet 204 may be coupled with shaft 206 such that shaft magnet 204 may be moveable by an operator via shaft 206. Shaft magnet 204 may be disposed centrally among Hall effect sensors 208-1 to 208-4, and may be moveable relative to Hall effect sensors 208-1 to 208-4. When an operator manipulates joystick 202, shaft 206 may displace shaft magnet 204 relative to Hall effect sensors 208-1 to 208-4. The manipulation may then result in changes of proximity between shaft magnet 204 and Hall effect sensors 208-1 to 208-4 and, thus, may cause the sensors to generate electrical signals corresponding to movement in directions of the manipulation. In certain embodiments, such manipulation directions may include a fore-aft direction and/or a side-to-side direction. Other directions, however, may also be used.

A fore-aft axis 210 and a side-to-side axis 212 are shown for reference to the fore-aft direction and the side-to-side direction. Shaft magnet 204 may be movable to any position within a central area of base portion 202. Movement in the fore-aft direction may generate a fore-aft signal, while movement in the side-to-side direction may generate a side-to-side signal. In certain embodiments, the fore-aft signal and the side-to-side signal may control different work machine operations. For example, the side-to-side signal may be a steering signal for steering work machine 100, while the fore-aft signal may be a lift signal for controlling work tool 104 of work machine 100.

Because Hall effect sensors 208-1 to 208-4 generate electrical signals based upon their proximity to shaft magnet 204, displacement of shaft magnet 204 may cause the sensors to generate electrical signals, especially when the displacement is in more than one axis. For example, when shaft magnet 204 moves along fore-aft axis 210 while keeping a same amount of displacement along side-to-side axis 212, Hall effect sensors 208-1 and 208-3, which monitor displacement of shaft magnet 204 along side-to-side axis 212, may still generate electrical signals because the displacement of shaft magnet 204 in fore-aft axis may cause the intensity and direction of the entire magnetic field produced by shaft magnet 204 to change. Similarly, displacement of shaft magnet 204 along side-to-side axis while keeping a same amount of displacement along fore-aft axis 210 may cause sensors 208-2 and 208-4 to generate electrical signals as well.

These undesired electrical signals corresponding to displacements of shaft magnet 204 in unrelated axes may introduce electrical noises or interference in both the fore-aft signal and the side-to-side signal. The fore-aft signal and the side-to-side signal may no longer be the ideal signals appropriately reflecting movement in the fore-aft and side-to-side directions, respectively. For example, the fore-aft signal may include a residue signal that is caused by the interference from the side-to-side signal; and the side-to-side signal may also include a residue signal that is caused by the interference from the fore-aft signal. When the operator manipulates joystick 108 in both fore-aft and side-to-side directions simultaneously to, for example, lift work tool 104 and steer work machine 100, the steering signal and the lifting signal may interfere with each other by generating residue signals. The steering signal and the lifting signals generated by joystick 108 may thus no longer be the ideal steering and lifting signals.

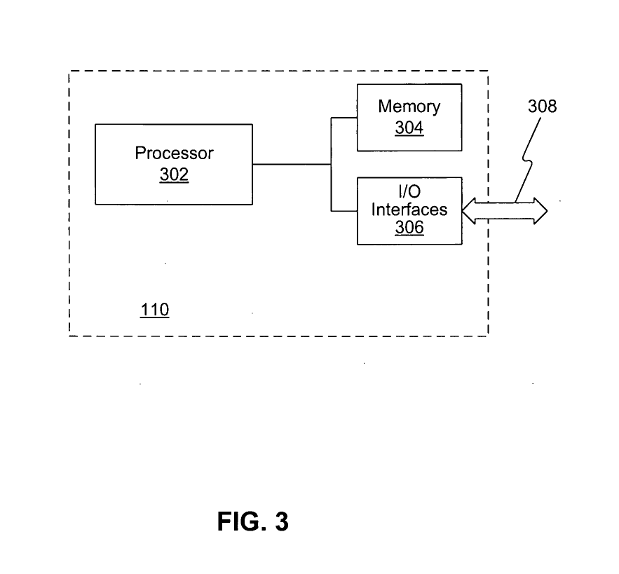

Furthermore, the greater the distance that shaft magnet 204 travels from the central area, the more electrical noise that may be generated. To obtain desired steering and lifting signals that are matching with or close to the ideal steering and lifting signals, both the fore-aft signal and the side-to-side signal, including electrical noise or residue signals, may further be communicated to control system 110. Control system 110 may then automatically process the electrical signals and reduce and/or remove the residue signals to generate desired fore-aft and side-to-side signals. FIG. 3 shows an exemplary functional block diagram of control system 110 consistent with the disclosed embodiments.

Control system 110 may be any appropriate type of control system to provide signal processing, data collection, data analysis, data communication, and any other data and/or control functionalities. As shown in FIG. 3, control system 110 may include a processor 302, a memory module 304, I/O interfaces 306, and I/O connections 308. Those skilled in the art will recognize that other components may also be included in control system 110. Additionally, control system 110 may coincide with an electronic control unit (ECU) (not shown) for work machine 100.

Processor 302 may include any appropriate type of processor, such as one or more general purpose central processing units (CPUs), digital signal processors (DSPs), or microcontrollers. In certain embodiments, processor 302 may communicate with other on-board systems to control other components (e.g., engine 102, work tool 104, etc.) of work machine 100 via predetermined protocols, such as J1939. Other communication protocols, however, may also be used.

Memory module 304 may include one or more memory devices including, but not limited to, a ROM, a flash memory, a dynamic RAM, and a static RAM. Memory module 304 may be configured to store information used by processor 302. Further, memory module 304 may be external or internal to processor 302. I/O interfaces 306 may include one or more input/output interface devices receiving data (e.g., control signals) from processor 302 and sending data (e.g., electrical signals from Hall effect sensors 208-1 to 208-4) to processor 302 via I/O connections 308.

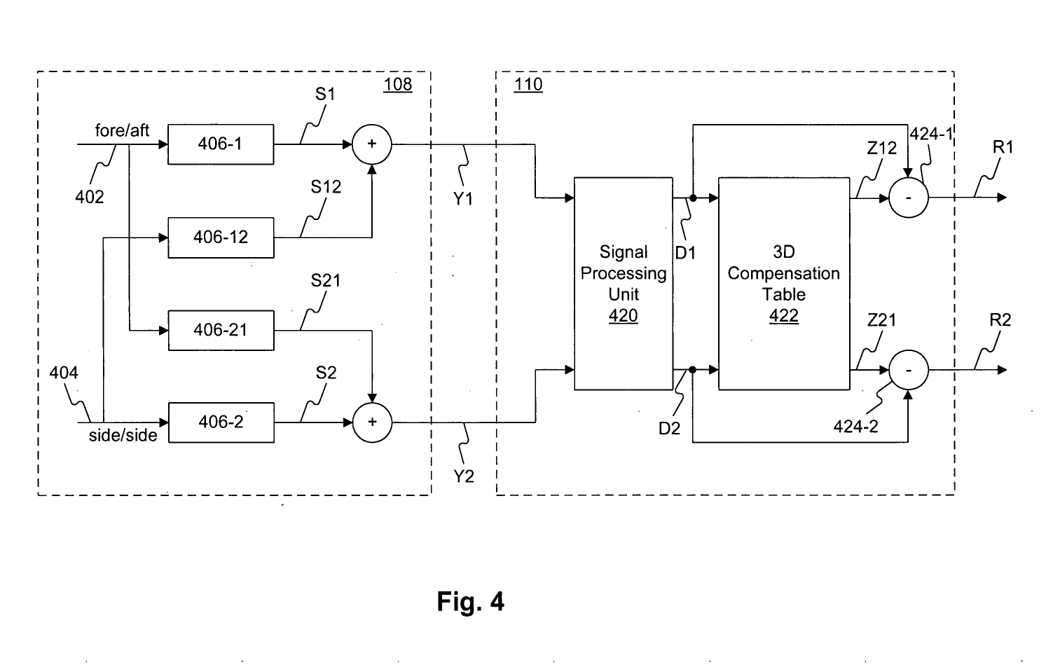

After control system 110 receives electrical signals from joystick 108, processor 302 may execute software programs to further process the electrical signals. FIG. 4 shows a block diagram of an exemplary signal processing flow. As shown in FIG. 4, an operator may manipulate joystick 108 to cause movements in both fore-aft and side-to-side directions, for instance, fore-aft movement 402 and side-to-side movement 404. Transfer functions 406-1, 406-12, 406-21, and 406-2 may then transfer such movements into electrical signals. Transfer functions may refer to sensing and signal processing functions provided by Hall effect sensors 208-1 to 208-4 and other relevant electronic components in joystick 108. Transfer function 406-1 may be a transfer function that generates an ideal fore-aft signal S1 that reflects the actual movement in the fore-aft direction without interference. As explained above, an interference may be caused by side-to-side movement 404. Transfer function 406-12 may then be presented to generate a residue signal S12 corresponding to the interference. A measured fore-aft signal Y1 may therefore include both ideal fore-aft signal S1 and residue signal S12.

Similarly, transfer function 406-2 may be a transfer function that generates an ideal side-to-side signal S2 that reflects the actual movement in the side-to-side direction without interference. As explained above, an interference may be caused by fore-aft movement 402. Transfer function 406-21 may then be presented to generate a residue signal S21 corresponding to the interference. A measured side-to-side signal Y2 may therefore include both ideal side-to-side signal S2 and residue signal S21.

Although the ideal fore-aft signal, side-to-side signal, and residue signals in fore-aft direction and side-to-side direction are shown to be generated by separate transfer functions, transfer functions may be performed by physical sensor devices simultaneously and automatically. Thus, the ideal fore-aft signals and side-to-side signals may be inseparable from the residue signals by joystick 108. Joystick 108 may only provide measured signals, rather than the ideal signals to control system 110. Accordingly, both measured signals Y1 and Y2 may then be passed by joystick 108 to control system 110 for further processing to generate desired signals that are matching with or close to the ideal signals S1 and S2.

Processor 302 may cause signals Y1 and Y2 to be processed by signal processing unit 420. Signal processing unit 420 may be any appropriate type of signal processing component, such as a signal processing hardware device. Alternatively, signal processing unit 420 may be implemented by software programs executed by processor 302. Signal processing unit 420 may amplify and filter signals Y1 and Y2, and may further convert signals Y1 and Y2 into digital signals D1 and D2, respectfully.

Processor 302 may then determine measured positions in both fore-aft direction and side-to-side direction based on signals D1 and D2. The measured positions may be percentage values indicating proximities relative to the neutral point of joystick 108 that may correspond to degrees of manipulations on work machine 100. For example, a 50% movement in the side-to-side direction may cause work machine 100 to be steered at a particular angle of, for example, 45 degrees. On the other hand, a 50% movement in the fore-aft direction may cause work tool 104 to be lifted, for example, half way between a lowest position and a highest position. Once processor 302 determines the measured positions or percentage values, processor 302 may further search a 3D compensation table 422 to determine residue signals Z12 and Z21 that are included in signals D1 and D2, respectively.

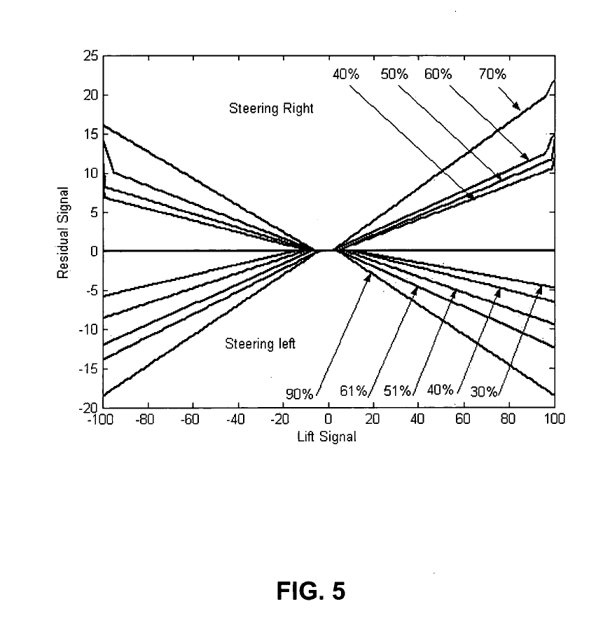

3D compensation table 422 may be created based on relationships among fore-aft signals, side-to-side signals, and residue signals. Such relationships may be predetermined based on experimental data or may be created dynamically by processor 302 based on predetermined criteria that may be specific to particular applications. FIG. 5 shows exemplary relationships among the side-to-side signals (e.g., steering signals), the fore-aft signals (e.g., lift signals), and residue signals.

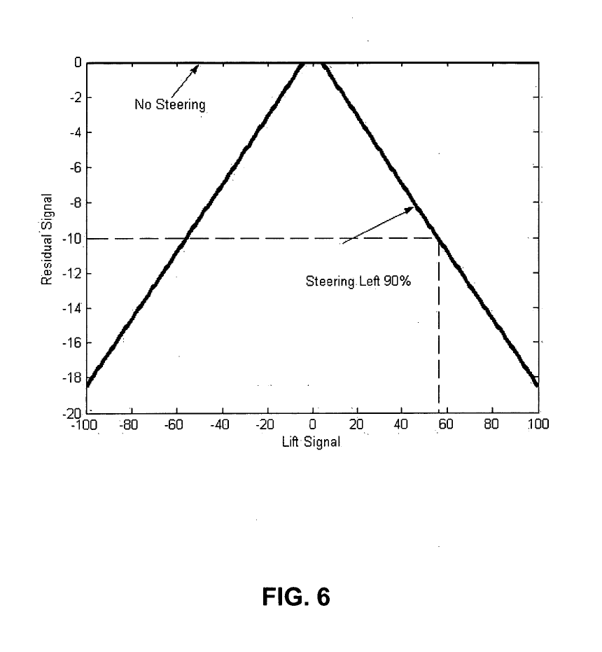

As shown in FIG. 5, residue signals, or interferences, may always be approximately zero or negligible when joystick 108 only moves in a single direction, that is, a symmetric movement. Residue signal values may increase when movements in both directions increase. For example, when the steering signal is of larger percentage value, a residue signal value may be larger for a same lift signal value corresponding to steering signals of smaller percentage values. FIG. 6 shows such relationship for a steering signal at 90% in a left direction. As shown in FIG. 6, when a lift signal is of a value of approximate 58%, a residue signal of −10 may be determined to be included in the steering signal. Therefore, the desired steering signal may be determined by subtracting the residue signal −10 from the measured steering signal (90%). Similarly, a residue value for a lift signal may also be determined either by a separate relationship mapping or by the same relationship mapping. In certain embodiments, such data may be measured by recording steering signals and lifting signals corresponding to predetermined joystick positions in a series of experimentation. For example, lift signals and residue signals may be measured by moving shaft 206 along fore-aft axis 210 while physically keeping shaft 206 at a known steering position. Similarly, residue signals and steering signals may also be measured by moving shaft 206 along side-to-side axis 212 while physically keeping shaft 206 at a known lifting position.

Returning to FIG. 4, 3D compensation table 422 may be implemented as computer instructions by using any appropriate data structures and/or algorithms. For example, 3D compensation table 422 may be a lookup table, a database, and/or any other data structures that may be readable by processor 302. Further, 3D compensation table 422 may be stored temporary or permanently in memory 304. In operation, processor 302 may determine corresponding position values of signals D1 and D2. Processor 302 may then search table entries of 3D compensation table 422 to determine a residue signal Z12 (i.e., interference in fore-aft direction) based on the values of D1 and D2. Processor 302 may also search table entries of 3D compensation table 422 to determine a residue signal Z21 (i.e., interference in side-to-side direction) based on the values of D2 and D1.

Further, processor 302 may also interpolate corresponding residue signals when a particular position value cannot be found. For example, a residue signal of a steering signal at 45%, if not found in the table, may be proportionally calculated based on steering signals at 40% and, for example, 50%. An average value between a residue signal value of a 40% steering signal and a residue signal value of a 50% steering signal may then be determined to be the residue signal value of the 45% steering signal. Other methods of interpolation, however, may also be used.

After determining fore-aft residue signal Z12, processor 302 may use subtractor 424-1 to deduct residue Z12 from fore-aft signal D1 to generate a desired fore-aft signal R1 corresponding to ideal fore-aft signal S1. Similarly, after determining side-to-side residue signal Z21, processor 302 may also use subtractor 424-2 to deduct residue Z21 from side-to-side signal D2 to generate a desired side-to-side R2 corresponding to ideal side-to-side signal S2. In certain embodiments, R1 may be equal to ideal fore-aft signal S1, if estimated residue signal Z12 is equal to residue signal S12. R2 may be equal to ideal side-to-side signal S2, if estimated residue signal Z21 is equal to residue signal S21. Processor 302 may further communicate desired signals R1 and R2 to other components of work machine 100 to cause operations of the components according to desired signals R1 and R2. Alternatively, processor 302 may directly control certain operations of work machine 100 based on desired signals R1 and R2. For example, work machine 100 may be steered by desired side-to-side signal R2 and work tool 104 may be operated by desired fore-aft signal R1. In certain other embodiments, desired signals R1 and R2 may approximately correspond to the respective ideal signals such that residue signals are reduced below a certain predetermined noise level.

### INDUSTRIAL APPLICABILITY

The disclosed systems and methods may eliminate or reduce the interference between correlated control signals of an input device, such as a multi-axis joystick. The disclosed systems and methods may determine the interference based on relationships among control signals corresponding to axes of the multi-axis joystick and residue signals. These relationships may be determined by experimentation or in real time by software programs. By determining and removing interference based on these relationships, complex and costly circuitries processing individual signals to filter or reduce interference may be eliminated. The disclosed systems and methods may thus provide accurate and low cost solutions where multiple control signals need to be processed and interference or noise among the multiple control signals need to be eliminated or reduced, such as control signals from work machine input devices or any other types of input devices.

Other embodiments, features, aspects, and principles of the disclosed exemplary systems will be apparent to those skilled in the art and may be implemented in various environments not limited to work site environments.

What is claimed is:

1. A method to process control signals of a multi-axis joystick, comprising:
processing a first control signal corresponding to movement in a first direction of the joystick;
processing a second control signal corresponding to movement in a second direction of the joystick;
determining a first residue signal based on interference characteristics between the first and second control signals; and
generating a first desired control signal corresponding to the first control signal by subtracting the first residue signal from the first control signal.

2. The method according to claim 1, further including:
determining a second residue signal based on interference characteristics between the first and second control signals; and
generating a second desired control signal corresponding to the second control signal by subtracting the second residue signal from the second control signal.

3. The method according to claim 1, wherein the first direction is a fore-aft direction.

4. The method according to claim 1, wherein the second direction is a side-to-side direction.

5. The method according to claim 1, wherein determining further includes:
establishing relationships among first direction control signals, second direction control signals, and residue signals; and
creating a database indicative of how particular residue signal values correspond to particular first direction control signal values and particular second direction signal values.

6. The method according to claim 5, wherein the database includes a 3D map of the residue signals, the first direction control signals, and the second direction control signals.

7. The method according to claim 1, wherein the first control signal is a steering signal used to steer a work machine.

8. The method according to claim 2, wherein the second control signal is a lifting signal used to operate a work tool of a work machine.

9. A method for operating a work machine by using a multi-axis joystick, comprising:
moving the joystick in a side-to-side direction to generate a steering signal;
concurrently moving the joystick in a fore-aft direction to generate a tool control signal to operate a work tool of the work machine;
processing the steering signal and the tool control signal;
determining a residue signal caused by interference between signals from the side-to-side direction and the fore-aft direction based on stored information indicating interference characteristics between the steering signal and the tool control signal; and
subtracting the residue signal from the steering signal to generate a desired steering signal.

10. The method according to claim 9, further including:
applying the desired steering signal to steer the work machine.

11. The method according to claim 9, further including:
subtracting the residue signal from the tool control signal to generate a desired tool control signal.

12. The method according to claim 11, further including:
applying the desired tool control signal to operate the work tool of the work machine.

13. A machine interface control system, comprising:
an input device configured to generate a first control signal and a second control signal, wherein the first control signal includes a first residue signal caused by interference between the first control signal and the second control signal;
a memory device configured to store information indicating interference characteristics between the first control signal and the second control signal; and
a controller configured to process the first control signal and the second control signal, wherein the controller is configured to:
determine the first residue signal based on the stored information and the first and second control signals; and
subtract the first residue signal from the first control signal to generate a first desired control signal.

14. The machine interface control system according to claim 13, wherein the controller is further configured to:
communicate the first desired control signal to a work machine to control a first function the work machine.

15. The machine interface control system according to claim 13, wherein the controller is further configured to:
determine a second residue signal based on the stored information and the first and second control signals; and
subtract the second residue signal from the second control signal to generate a second desired control signal.

16. The machine interface control system according to claim 15, wherein the controller is further configured to:
communicate the second desired control signal to a work machine to control a second function the work machine.

17. A work machine, comprising
a steering device;
a work tool;
a multi-axis joystick capable of generating a first control signal and a second control signal, wherein the first control signal includes a first residue signal caused by interference between the first control signal and the second control signal;
a controller configured to:
determine the first residue signal based on the first and second control signals and stored information indicating interference characteristics of the multi-axis joystick;
subtract the first residue signal from the first control signal to generate a first desired control signal; and
control the steering device of the work machine based on the first desired control signal.

18. The work machine according to claim 17, wherein the controller is further configured to:
determine a second residue signal based on the first and second control signals and stored information indicating interference characteristics of the multi-axis joystick;
subtract the second residue signal from the second axis control signal to generate a second desired control signal; and
control operation of the work tool of the work machine based on the second desired control signal.
